(19) United States
(12) Patent Application Publication
(10) Pub. No.: US 2025/0320848 A1
(43) Pub. Date: Oct. 16, 2025

(54) FUEL INJECTOR

(71) Applicant: PHINIA DELPHI LUXEMBOURG SARL, Belvaux (LU)

(72) Inventors: Frédéric SAUVAGE, Beaugency (FR); Richard ENTERS, Vineuil (FR); Nicolas CEZON, Ingre (FR); Nicolas RODIER, Vineuil (FR)

(21) Appl. No.: 18/868,308

(22) PCT Filed: May 22, 2023
(86) PCT No.: PCT/EP2023/063629

§ 371 Date: Nov. 22, 2024

(30) Foreign Application Priority Data
May 23, 2022 (GB) 2207522.0

(51) Int. Cl. F02M 51/06

(52) U.S. Cl. CPC F02M 51/0664; F02M 2200/07

(57) ABSTRACT

A fuel injector comprising:
a housing extending axially along an injector axis from a proximal end to a distal end and having a nozzle at the distal end,
a pintle having an axially extending pintle shaft, the pintle being axially movable between an open position and a closed position in which it closes the nozzle from the inside,
an armature disposed in a cavity of the housing to be axially movable between a proximal position and a distal position and having an axial through-hole in which the pintle shaft is received,
a magnetic coil, and
a pole piece disposed in the housing-proximally of the armature.

At least one axially movable element of the fuel injector comprises a first contact surface for engaging an axially opposite second contact surface of another element. One of the contact surfaces is a divided contact surface.

### TECHNICAL FIELD

The invention relates to a fuel injector and to an engine system.

### BACKGROUND ART

Fuel injectors are used in combustion engines to inject fuel e.g., into a runner of an air intake manifold ahead of a cylinder intake valve or directly into the combustion chamber of an engine cylinder. According to one known design, a pintle and an armature are disposed within an injector housing. The pintle is movable between a closed position, in which it (or a ball that is fixed to the pintle) closes a nozzle at one end of the injector housing, and an open position, in which it is moved away from the nozzle, thereby enabling fuel injection. The pintle traverses a through-hole in the armature, and the armature is movable within the injector housing. In order to open the injector nozzle, a magnetic field is generated by a magnetic coil, which magnetic field is enhanced by a pole piece disposed proximally (i.e. away from the nozzle end of the injector) of the armature and moves the armature away from the nozzle. The armature in turn has a contact surface that engages a corresponding contact surface of the pintle to move the pintle away from the nozzle. Commonly, a first spring is disposed to bias the pintle towards the nozzle and a second spring is disposed to bias the armature towards the nozzle.

During its movement, the armature alternatingly makes contact and is separated from the pole piece, the pintle etc. Since all these parts are inside the injector housing, which is filled with fuel, a considerable hydraulic contact force acts against the separation process, thus leading to a so-called sticking effect. This in turn makes it difficult to guarantee a reliable, repeatable motion cycle of the fuel injector. As a rule, the sticking effect increases with the area of the contact surface. Accordingly, it is known to minimize the area by providing e.g., an annular surface with minimal width, thereby making it essentially one-dimensional. However, such a small area increases the stress on the contact surfaces during each contact, which reduces the lifetime of the injector. Also, with such a narrow contact surface, the contact process can differ significantly from one contact to the next (“shot-to-shot”), i.e., repeatability is impaired.

### Technical Problem

It is thus an object of the present invention to provide a fuel injector with a reliably operability and long lifetime.

This problem is solved by a fuel injector according to claim 1 and by an engine system according to claim 14.

### General Description of the Invention

The invention provides a fuel injector. Specifically, this is a fuel injector for a combustion engine. It can be configured for direct injection or for indirect injection.

The fuel injector comprises a housing extending along an injector axis from a proximal end to a distal end and having a nozzle at the distal end. One main function of the housing is to contain and guide fuel before it is ejected from the injector. Usually, the housing comprises a plurality of pieces or components that are stationarily connected with each other. At least those parts of the housing that come into contact with the fuel can be made of stainless steel. The housing has a nozzle for ejecting the fuel, which nozzle is disposed at a distal end. The terms “distal” as well as “proximal” refer to the general flow direction of the fuel within the injector towards the distal end. In general, the distal end is the end of the injector that is closer to the nozzle and the proximal end is the end that is further away. The injector extends along an injector axis from the proximal end to the distal end. At least some parts of the injector can be symmetric with respect to the injector axis, but in general this injector axis only defines a reference frame, whereby an axial direction, a radial direction and a tangential direction are implicitly defined.

The injector further comprises a pintle having an axially extending pintle shaft and being axially movable between an open position and a closed position in which it closes the nozzle from the inside. As a rule, the pintle is made of stainless steel. The pintle shaft is normally cylindrical and elongate, with a length of the pintle shaft corresponding to e.g., more than 10 times its diameter. In some embodiments, a ball is fixed to a distal end of the pintle. The ball may also be considered as a part of the pintle. In the closed position, the pintle (or the ball, respectively) closes the nozzle from the inside and prevents fuel from being ejected. In a typical embodiment, the ball engages a nozzle seat at the distal end of the housing (from the inside of the housing), thereby closing the nozzle. By axially moving the pintle in a proximal direction, it can be moved to an open position in which the nozzle is open, and fuel can be ejected.

The fuel injector further comprises an armature that is disposed in a cavity of the housing to be axially movable between a proximal position and a distal position and having an axial through-hole in which the pintle shaft is received. In other words, the armature is disposed in the cavity so that it is movable along the injector axis between the proximal position and the distal position. Here and the following, “along the injector axis” particularly, but not exclusively, means “parallel to the injector axis”. More generally, it means “at least partially in the direction of the injector axis”. The moving principle of the armature is not limited within the scope of the invention, but normally the armature is moved to the proximal position by a magnetic field, while it is moved to the distal position by spring force, wherein at least one movement could be assisted by fuel pressure and/or gravity. Normally, the armature is made of stainless steel. The armature has an axial through-hole in which the pintle shaft is received. The shape of the through-hole is normally adapted to provide a guiding function between the armature and the pintle shaft. Radially outside of the through-hole, the armature usually comprises at least one fuel channel that traverses the armature, usually a plurality of fuel channels.

Preferably, the pintle has a radially projecting pintle perch. Normally, the pintle shaft and the pintle perch are formed from a single piece. At least, the pintle perch is axially fixed to the pintle shaft. Also, the armature is adapted to engage the pintle perch to transfer an axial force. Normally, this force moves the pintle into the open position when the armature moves to the proximal position, but it could also move the pintle into the closed position when the armature moves into the distal position. As the armature engages the pintle perch, the proximal movement (or distal movement, respectively) of the armature is transferred to the pintle.

Also, the fuel injector comprises a magnetic coil. The magnetic coil or solenoid is configured for generating a magnetic field to move the armature to the proximal position. The magnetic coil may be e.g., circumferentially disposed around the injector axis. It is normally disposed radially outside of a housing wall of the housing, while the armature is disposed radially inside. As a current flows through the magnetic coil, a magnetic field is generated. Although the windings of the magnetic coil are individually isolated in order to avoid any short circuit, the magnetic coil as a whole is normally encapsulated in a non-conducting casing, e.g. made of plastic.

The fuel injector further comprises a pole piece disposed in the housing proximally of the armature. Normally, the pole piece is disposed in the cavity, where it is offset along the axial direction with respect to the armature. It is disposed proximally of the armature, i.e., on a proximal side of the armature. Normally, the pole piece is at least partially disposed radially inside of the abovementioned housing wall, e.g., in the same cavity as the armature. The pole piece may as well be disposed circumferentially around the injector axis and may have an annular shape. The axial position of the pole piece can more or less correspond to the axial position of the magnetic coil. The function of the pole piece is to be magnetised when the magnetic coil generates a magnetic field and to attract the distally disposed armature. With respect to the absence of a pole piece, the magnetic field is shaped and/or enhanced.

A first spring may be disposed between the housing (or the pole piece) and the pintle perch to distally bias the pintle. “Bias distally” in this context means that a biasing force is exerted in the distal direction. The function of the first spring may be to keep the pintle perch in contact with the armature and to bring the distal end of the pintle into contact with the nozzle seat. In other words, the armature has to counteract and overcome the force of the first spring to move the pintle away from the nozzle seat. Also, a second spring can be disposed between the pole piece and the armature to distally bias the armature. The first and second spring are normally coil springs that are centered about the injector axis.

At least one axially movable element of the fuel injector comprises a first contact surface for engaging an axially opposite second contact surface of another element. In particular, the axially movable element can be the armature and/or the pintle, while the other element could be the pole piece, the housing etc. The other element could be stationary but could also be another axially movable element itself. While the externally movable element comprises the first contact surface, the second contact surface is part of a different element that the axially movable element engages in the course of its motion cycle. Commonly, both contact surfaces (the respective elements) are made of stainless steel, but at least one could be made of a different material, e.g., plastic. The first and second contact surface are axially opposite to each other, i.e., they are opposite to each other along the axial direction.

One of said contact surfaces is a divided contact surface that is radially delimited by an inner radius and an outer radius and is projecting towards the other contact surface, wherein at least two contact portions of the divided contact surface are separated by an interposed recess portion that is recessed with respect to the contact surface, and the other contact surface is shaped to engage the divided contact surface while being spaced from each recess portion. The divided contact surface can be the first contact surface or the second contact surface, i.e., it can be disposed on the axially movable element or the other element. It is delimited by an inner radius and outer radius, i.e., the entire divided contact surface is disposed between the inner and outer radius. The inner radius corresponds to the radial position of the innermost part of the divided contact surface while the outer radius corresponds to the radial position of the outermost part of the divided contact surface. With respect to adjacent surfaces of the respective element, the divided contact surface projects towards the opposite contact surface. In particular, the divided contact surface may be disposed on at least one ridge portion of the respective element.

At least two contact portions of the divided contact surface are separated by an interposed recess portion that is recessed with respect to the divided contact surface. The contact portions are portions or parts of the divided contact surface. They may be connected (e.g., via another contact portion) or maybe completely separate from each other. In any case, a recess portion is interposed between the two contact portions, so that they are at least locally separated by this recess portion. One could also say that the recess portion divides the contact surface by (at least locally) separating the contact portions, hence the term “divided contact surface”. However, it should be noted that in some embodiments, the divided contact surface could be coherent, e.g., with one or several recess portions being disposed inside the contact surface. Even in this case, though, the divided contact surface is interrupted by the recess portion(s).

The other contact surface is shaped to engage the divided contact surface while being spaced from each recess portion. In other words, the shape of the (axially opposite) other surface is adapted so that it does not engage or come into contact with any recess portion while it engages the divided contact surface.

During the motion cycle of the axially movable element, the first and second contact surface engage and disengage repeatedly. Since the space between the elements is filled with fuel during operation of the fuel injector, this fuel has to be displaced in order to allow the contact surfaces to engage, while the other hand, disengaging the contact surfaces is hindered by a hydraulic contact force that may lead to sticking. By dividing or interrupting the area of the divided contact surface, this sticking effect can be greatly reduced. While the effects and advantages of the invention are not bound by this explanation, it may be beneficial that fuel can remain in a recess portion even while the neighboring contact portions are in direct contact with the axially opposite contact surface, or fuel may flow through a recess portion so that it can reach certain parts of a contact portion faster. On the other hand, in contrast to an uninterrupted line-shaped contact portion known in the art, the divided contact surface of the invention may span over a considerable area between the inner radius and the outer radius. This helps to evenly distribute impact forces as the first and second contact surface engage, thereby reducing stress and increasing the lifetime of the fuel injector.

According to one option, the fuel injector is a gasoline injector and at least one divided contact surface comprises two radially spaced contact portions separated by a radially interposed recess portion. According to another option, the fuel injector is a diesel injector and at least one divided contact surface comprises two tangentially spaced contact portions separated by a tangentially interposed recess portion. It will be understood that a gasoline injector is adapted to inject gasoline directly or indirectly into a gasoline engine, while a diesel injector is adapted to inject diesel directly or indirectly into a diesel engine. The inventors have found that different types of divided contact surfaces are favorable for diesel injectors and gasoline injectors. Without limiting the invention to this explanation, the different density and/or different viscosity of gasoline (including ethanol/gasoline mixtures, e.g. E5 or E10) on the one hand and diesel on the other hand may influence the flowing properties so that the sticking effect can be better suppressed with differently designed surfaces depending on the type of fuel. In case of a gasoline injector, at least one divided contact surface comprises two radially spaced contact portions separated by a radially interposed recess portion. The recess portion is interposed between the contact portions along the radial direction. Preferably, the contact portions are completely separated by the recess portion. In case of a diesel injector, at least one divided contact surface comprises two tangentially spaced contact portions separated by a tangentially interposed recess portion. The recess portion is interposed between the contact portions along the tangential direction. Preferably, the contact portions are completely separated by the recess portion.

One embodiment provides that the armature has a first armature contact surface for engaging an axially opposite pintle contact surface of the pintle and one of the first armature contact surface and the pintle contact surface is a divided contact surface. As mentioned above, the armature, which is directly moved by the magnetic field, engages the pintle to move it, normally from the closed position to the open position. Accordingly, the first armature contact surface is normally disposed on a proximal side of the armature, while the pintle contact surface may be disposed on a distal side of the above-mentioned pintle perch.

In order to limit a proximal movement of the armature with respect to the housing, the armature may comprise a second armature contact surface for engaging a pole-piece contact surface of the pole piece (when the armature is in the proximal position). One embodiment provides that one of the second armature contact surface and the pole-piece contact surface is a divided contact surface. As mentioned above, the pole piece is proximally disposed with respect to the armature and as the armature moves into its proximal position, it engages the pole-piece contact surface with the second armature surface.

According to one embodiment, the armature has a third armature contact surface for engaging an axially opposite contact surface, wherein the third armature contact surface is disposed distally on the armature and one of the third armature contact surface and the axially opposite contact surface is a divided contact surface. In this embodiment, the armature is the axially movable element. The third armature contact surface is disposed distally on the armature, i.e., on a distal side thereof. Therefore, it faces away from the pole piece. In this embodiment, it is preferred that the third armature surface is a divided contact surface. Preferably, the third armature surface is adapted to at least indirectly engage the housing. It may either directly engage the housing or indirectly via an interposed stop ring. This embodiment is particularly helpful in reducing the sticking effect as the armature moves away from the distal position and towards the proximal position.

According to one embodiment, the third armature contact surface is adapted for engaging an axially opposite housing contact surface of the housing, and one of the third armature contact surface and the housing contact surface is a divided contact surface. The axially opposite housing contact surface is a surface of the housing, which may be at the transition from the wider cavity in which the armature is disposed to a narrower cavity in which the pintle shaft is received.

According to one embodiment, the fuel injector comprises a stop ring axially interposed between the armature and the housing, and the third armature contact surface is adapted for engaging an axially opposite stop-ring contact surface of the stop ring, wherein one of the third armature contact surface and the stop-ring contact surface is a divided contact surface. The use of a stop ring is known in the art as such. It is interposed between the armature and the housing so that the armature does not directly engage the housing but engages the stop ring which in turn transfers an axial force between the armature and the housing. Normally, the stop ring is made of non-magnetisable material, e.g. plastic or metal. While it is not fixed to the housing, it normally does not move axially with respect to the housing. However, the armature will alternatingly engage and disengage from the stop ring. As mentioned above, the third armature contact surface is normally distally disposed.

It will be understood that the terms “first”, “second” and “third armature contact surface” only serve to distinguish these contact surfaces and any of these contact surfaces could be present without one or both of the other two. Also, these terms are interchangeable, i.e., the first, second and third armature contact surface could be referred to as the second, third and first armature contact surface, or the like.

In the case of several divided surfaces, it is possible that the housing contact surface, the stop-ring contact surface, the pintle contact surface and/or the pole-piece contact surface are divided surfaces. However, it may be beneficial if all divided contact surfaces are located on the armature, so that the other elements may possibly correspond to prior art and the armature is the only element that has to be modified.

Preferably, the two radially spaced contact portions are annular. These annular contact portions can be described as two concentric rings that are separated by the (also concentric) recess portion. The outer dimensions of the outer contact portion may correspond to the outer radius of the divided contact surface, while the inner dimensions of the inner contact portion correspond to the inner radius.

At least one divided contact surface may comprise a plurality of tangentially (circumferentially) spaced contact portions and a plurality of tangentially interposed recess portions alternatingly disposed along the tangential direction. In other words, a recess portion is disposed between every two contact portions and vice versa. The number of contact portions (or recess portions, respectively) is not limited but may in particular be between 2 and 50 or between 3 and 20. The tangential dimension of the recess portions could be considerably smaller than the tangential dimension of the contact portions, e.g., down to 5% of said dimension, but could also be comparable to the tangential dimension of the contact portions, e.g. corresponding to between 80% and 120% or even more. It is to be understood that the tangential dimension of the recess portions may also be between 5% and 80% of the tangential dimension of the contact portions.

One embodiment provides that at least one contact portion and/or at least one recess portion is aligned parallel to the radial direction. The respective portion is either parallel to the radial direction (e.g., if it has a small tangential dimension) or its edges are parallel to the radial direction. It may correspond to a section of an arc centered around injector axis.

Another embodiment provides that at least one contact portion and/or at least one recess portion is aligned oblique to the radial direction and the tangential direction. This again pertains either to the portion as such or to its edges. The overall shape of the section may correspond to a portion of a spiral originating from the injector axis. By adapting the alignment of the recess portion, the flow of fuel through said portion may be influenced, e.g., accelerated or slowed.

It is preferred that the at least one recess portion corresponds to between 25% and 75% of an area between the inner radius and the outer radius. More specifically, it may correspond to between 40% and 60% of this area. Accordingly, a considerable part, or even a major part of the area does not belong to the contact surface, which reduced the abovementioned sticking effect. “The at least one recess portion” refers to all recess portions that separate contact portions of the divided contact surface, i.e., possibly only one recess portion.

As mentioned above, the shape of the contact surface opposite the divided contact surface does not correspond to the recess portion(s), so that it does not contact any of the recess portions. While the divided contact surface with its contact portions and the recess portion(s) may correspond to an uneven surface with ridges or the like, the opposite contact surface can be more or less even. Preferably, the axially opposite contact surface has a minimum curvature radius corresponding to at least 50% of the inner radius. This also includes the possibility that the contact surface is flat, so that the (minimum) curvature radius is infinite. An angled surface, i.e., a surface with at least one edge, is considered to have a curvature radius of (almost) zero. Accordingly, in this embodiment, the opposite contact surface has no angles and either no curvature or only a relatively moderate curvature. In particular, it is possible that the opposite contact surface is flat.

During production of the element with the divided contact surface, the structure with the contact portions and the recess portion (as) can be created in various ways. In particular, at least one recess portion can be produced by a forming process and/or a material removing process performed in the area between the inner radius and the outer radius. “Forming” refers to any process that changes the shape of the material without removing or adding material. This may be hot forming or also cold forming. The latter is also made possible by the fact that the recessed portion is normally recessed by less than 1 mm with respect to the contact portions. Possible forming processes include, but are not limited to, rolling, stamping and knurling. Suitable material removing processes include, but are not limited to, machining, turning, milling, etching and laser ablation. In particular, at least one divided contact surface may comprises a multiplicity of alternating, radially aligned contact portions and recess portions, formed by knurling. The number of contact portions may be e.g., between 10 and 100 or between 20 and 50.

The invention further relates to an engine system with a combustion engine and at least one fuel injector adapted to inject fuel at least indirectly into the engine, the fuel injector comprising:
a housing extending axially along an injector axis from a proximal end to a distal end and having a nozzle at the distal end,
a pintle having an axially extending pintle shaft, the pintle being axially movable between an open position and a closed position in which it closes the nozzle from the inside,
an armature disposed in a cavity of the housing to be axially movable between a proximal position and a distal position and having an axial through-hole in which the pintle shaft is received,
a magnetic coil, and
a pole piece disposed in the housing proximally of the armature,
   wherein at least one axially movable element of the fuel injector comprises a first contact surface for engaging an axially opposite second contact surface of another element, one of said contact surfaces being a divided contact surface that is radially delimited by an inner radius and an outer radius and is projecting towards the other contact surface, wherein at least two contact portions of the divided contact surface are separated by an interposed recess portion that is recessed with respect to the divided contact surface, and the other contact surface being shaped to engage the divided contact surface while being spaced from each recess portion, wherein the engine is a gasoline engine, the fuel injector is a gasoline injector and at least one divided contact surface comprises two radially spaced contact portions separated by a radially interposed recess portion, or the engine is a diesel engine, the fuel injector is a diesel injector and at least one divided contact surface comprises two tangentially spaced contact portions separated by a tangentially interposed recess portion.

The injector can be adapted to inject fuel directly into the engine, specifically into a combustion chamber of the engine. Alternatively, it can be adapted for indirect injection, i.e., to inject fuel into an intake duct of the engine. Although the engine and the injector are considered as components of the engine system, it is also possible to regard the injector (and possibly the intake duct) as part of the engine. All other terms have been discussed with respect to the inventive fuel injector and will not be explained again. Preferred embodiments of the inventive engine system correspond to those of the inventive injector.

The combustion engine is typically an internal combustion engine with a plurality of cylinders, configured for a for stroke cycle. The injector is part of a fuel delivery system comprising a fuel tank comprising the relevant fuel (diesel resp. gasoline), at least one fuel pump to forward fuel from the tank to a fuel rail, to which the injector(s) is/are connected. The gasoline engine includes spark plugs. The fuel delivery system of the diesel engine is designed to operate at comparatively higher pressures and uses compression ignition.

### BRIEF DESCRIPTION OF THE DRAWINGS

Preferred embodiments of the invention will now be described, by way of example, with reference to the accompanying drawings, in which:

FIG. 1 is a longitudinal cross-sectional view through an inventive fuel injector;

FIG. 2 is a detail view of FIG. 1;

FIG. 3 is a perspective view of a first embodiment of an armature for the fuel injector from FIG. 1;

FIG. 4 is a perspective view of a second embodiment of an armature;

FIG. 5 is a perspective view of a third embodiment of an armature;

FIG. 6 is a perspective view of a first embodiment of a pole piece for the fuel injector from FIG. 1; and

FIG. 7 is a perspective view of a second embodiment of a pole piece for the fuel injector from FIG. 1;

FIG. 8 is a detail cross sectional view of FIG. 4;

FIG. 9 is a detail cross sectional view of an alternative design of the second armature contact surface of the armature of FIG. 3.

### DESCRIPTION OF PREFERRED EMBODIMENTS

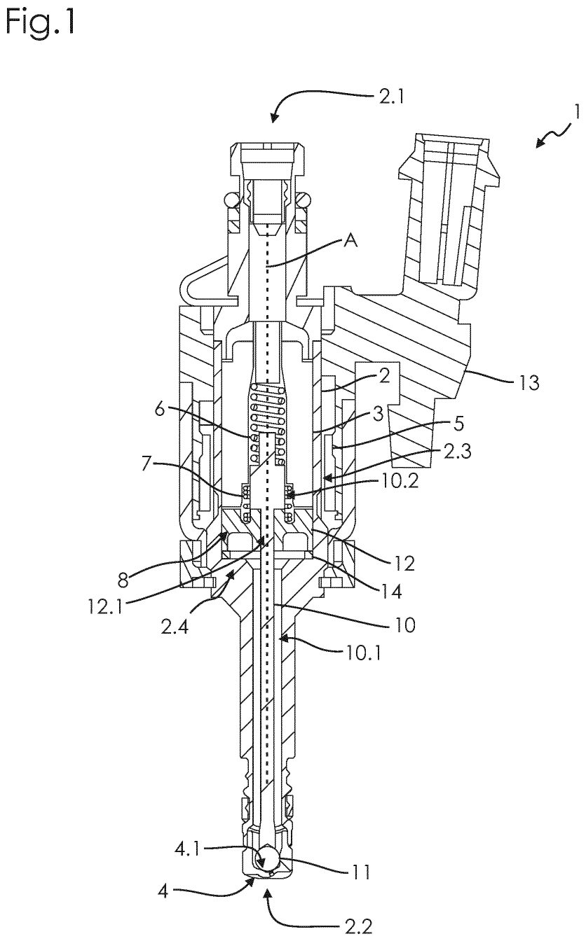

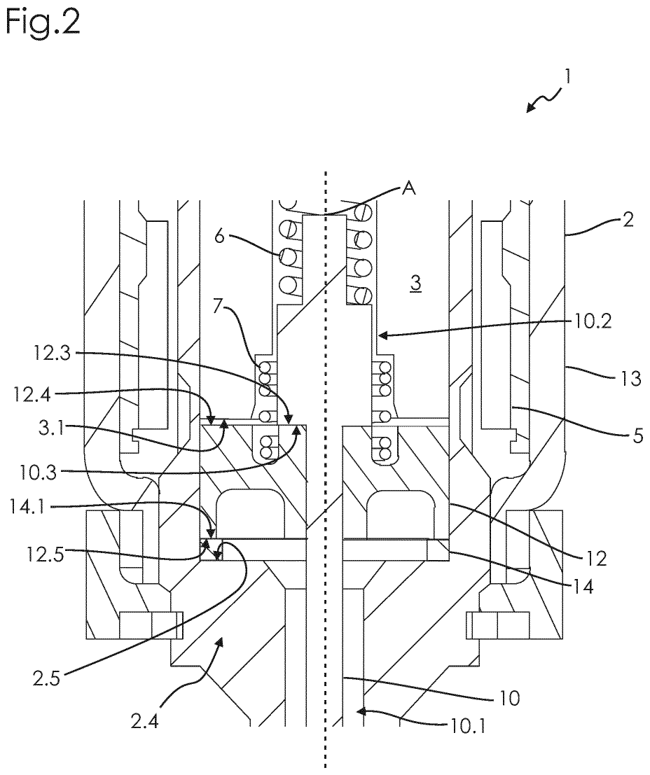

FIGS. 1 and 2 schematically show an inventive fuel injector 1, which can be used in a combustion engine, like a diesel engine or a gasoline engine. It can be used in an inventive engine system that comprises the combustion engine and the fuel injector 1. While certain features may differ depending on whether the fuel injector 1 is a gasoline injector or a diesel injector, FIGS. 1 and 2 are to be understood as representing both types of injector. The fuel injector 1 comprises a housing 2 consisting of several stainless-steel parts, which are not explained here in detail. The housing 2 extends along an injector axis A from a proximal end 2.1 to a distal end 2.2, where a nozzle 4 is disposed. A cavity 8 is formed inside the housing 2, which extends up to the nozzle 4 and is adapted for guiding fuel through the fuel injector 1.

The nozzle 4 can be closed by a stainless-steel pintle 10 that is disposed within the housing 2. The pintle 10 has an axially extending, elongate pintle shaft 10.1, from which an annular collar, referred to as pintle perch 10.2, projects radially. The pintle 10 is axially movable between an open position (not shown) and a closed position, which is represented by FIGS. 1 and 2. In the closed position, a ball 11 at a distal end of the pintle 10 rests against a nozzle seat 4.1 of the nozzle 4, whereby the nozzle 4 is closed. If the pintle 10 moves proximally towards the open position, the ball 11 is lifted away from the nozzle seat 4.1, whereby the nozzle 4 is opened. A first spring 6 is disposed between the pintle perch 10.2 and a pole piece 3 that is connected to the housing 2. The first spring 6 is a coil spring that is aligned along the injector axis A and exerts a force to distally bias the pintle 10, i.e., to bias the pintle 10 in a distal direction.

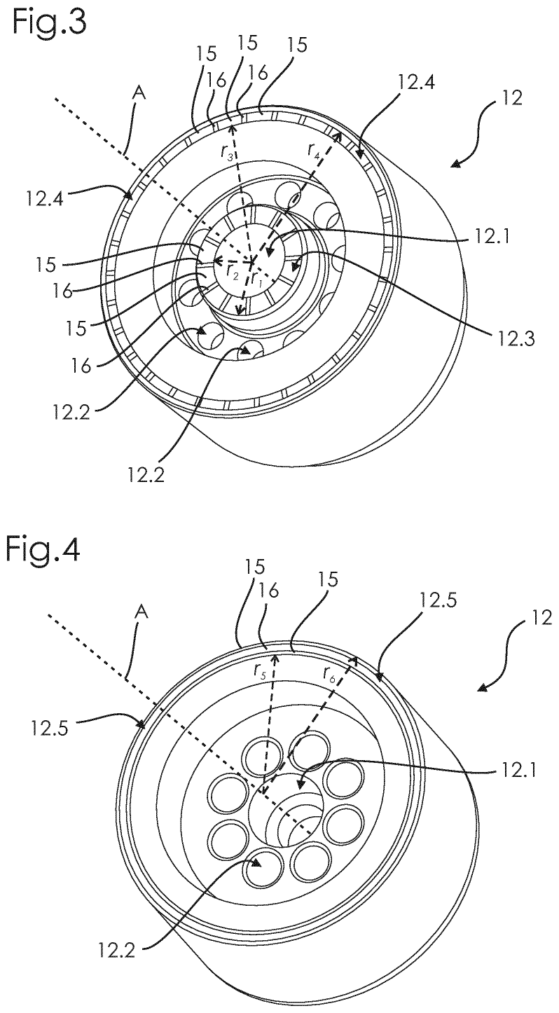

The fuel injector 1 further comprises an armature 12 that has a roughly annular shape and surrounds the pintle 10. The armature 12 has an axial through-hole 12.1 in which the pintle shaft 10.1 is received. The armature 12, which is also made of stainless steel, can move axially along the pintle shaft 10.1, but radial movement with respect to the pintle 10 is greatly limited. Radially outside with respect to the through-hole 12.1, the armature 12 comprises a plurality of fuel channels 12.2 (see FIGS. 3-5) that communicate with the cavity 8 in order to allow passage of fuel through the armature 12. The armature 12 is axially movable in the housing 2 between a proximal position and a distal position. In the distal position, which is shown in FIG. 1, a first armature contact surface 12.3 is in contact with a pintle contact surface 10.3 of the pintle, while a second armature contact surface 12.4 on a proximal side of the armature 12 is axially separated from an opposite pole-piece contact surface 3.1 of pole piece 3. A third armature contact surface 12.5 rests against an axially opposite stop-ring contact surface 14.1 of a stop ring 14 that is interposed between the armature 12 and a stop portion 2.4 of the housing 2. The stop ring 14 is made of non-magnetisable material, e.g., plastic. In the proximal position, which is not shown in the figures, the second armature stop surface 12.4 engages the pole piece stop surface 3.1.

The cavity 8 is delimited by a housing wall 2.3 disposed adjacent the armature 12 and the pole piece 3. A magnetic coil 5 is disposed radially outside the housing wall 2.3. It is encapsulated in a plastic casing 13 to provide electric isolation. If a current flows through the magnetic coil 5, a magnetic field is generated, which also enters the pole piece 3 and the armature 12, whereby the armature 12 is pulled towards the pole piece 3 and into the proximal position. A second spring 7 is disposed between the housing 2, or more specifically, the pole piece 3, and the armature 12 to distally bias the armature 12. As long as no magnetic field is acting on the armature 12, it is kept in the distal position by the second spring 7.

The magnetic flux can also reach the stop portion 2.4 opposite the third armature contact surface 12.5. This could lead to a magnetic force acting on the armature 12 in the distal direction, thereby delaying the liftoff of the armature 12. In order to avoid this, the non-magnetisable stop ring 14 is interposed to keep the armature 12 at a distance from the stop portion 2.4.

As the armature 12 moves to the proximal position, it engages the pintle perch 10.2, whereby an axial force is transferred to move the pintle 10 into the open position. More specifically, the first armature contact surface 12.3 engages the pintle contact surface 10.3 to transfer said force.

As the armature 12 and the pintle 10 move axially between their respective end positions, the armature contact surfaces 12.3-12.5 alternatingly engage and disengage axially opposite contact surfaces 3.1, 10.3, 14.1. Since the space in between the elements is filled with fuel, this fuel has to be displaced in order to allow the contact surfaces 3.1, 10.3, 12.3-12.5, 14.1 to engage, while the other hand, disengaging the contact surfaces 3.1, 10.3, 12.3-12.5, 14.1 is hindered by a hydraulic contact force that may lead to sticking. In order to reduce the sticking effect, one of each pair of axially opposite contact surfaces 3.1, 10.3, 12.3-12.5, 14.1 is a divided contact surface.

FIG. 3 shows a first embodiment of an armature 12, in which each of the first armature contact surface 12.3, the second armature contact surface 12.4 and the third armature contact surface 12.5 is a divided contact surface. The armature 12 is adapted to be used in a diesel injector. As shown in FIG. 3, the first armature contact surface 12.3 is disposed in an annular area between a first inner radius r₁ and a first outer radius r₂. It is, however, not a single, contiguous area but it comprises a plurality of contact portions 15 (here: twelve contact portions 15) which are tangentially (circumferentially) separated by interposed recess portions 16, which are aligned parallel to the radial direction. While the contact portions 15 project towards the axially opposite pintle contact surface 10.3, the recess portions 16 are recessed with respect to the contact portions 15. The recessed portions 16 may thus also be referred to as grooved portions. Accordingly, since the pintle contact surface 10.3 is flat, only the contact portions 15 engage the pintle contact surface 10.3, while the recess portions 16 stay out of contact. It has been found that by dividing or interrupting the area of the divided contact surface, in this case the first armature contact surface 12.3, the sticking effect can be greatly reduced. On the other hand, since the first armature contact surface 12.3 spans over a considerable area between the first inner radius r₁ and the first outer radius r₂, any impact forces occurring are well distributed, thereby reducing stress and increasing the lifetime of the fuel injector 1. In the embodiment shown, the recess portions 16 correspond to about 25% of an area between the first inner radius r₁ and the first outer radius r₂, but this percentage could be lower or higher, e.g., up to 75% or more. In general, in the various embodiments, the contact portions 15 may generally have a flat surface (i.e. surface that engage with contact surface of the opposite element—here the pintle contact surface 13).

As shown in FIG. 3, the second armature contact surface 12.4 is disposed in an annular area between a second inner radius r₃ and a second outer radius r₄. It comprises a plurality of contact portions 15 (here: 30 contact portions 15) which are tangentially separated by interposed recess portions 16. The axially opposite pole-piece contact surface 3.1 is substantially flat. In the embodiment shown, the recess portions 16 correspond to about 20% of an area between the second inner radius r₃ and the second outer radius r₄, but this percentage could be lower or higher, e.g., between 25% and 75% or more. The third armature contact surface 12.5 is not shown for this embodiment, but has a configuration similar to the first and second armature contact surface 12.3, 12.4. in that it also comprises a plurality of contact portions 15 which are tangentially separated by interposed recess portions 16, which are aligned parallel to the radial direction.

FIG. 4 shows a second embodiment of an armature, which is adapted for use in a gasoline injector. As can be seen in FIG. 4, the third armature contact surface 12.5 is disposed in an annular area between a third inner radius r₅ and a third outer radius r₆. It comprises two annular contact portions 15 that are concentrically arranged and are radially spaced by an interposed annular recess portion 16. The axially opposite stop-ring contact surface 14.1 is substantially flat. Here, the recess portion 16 corresponds to about 40% of an area between the second inner radius r₃ and the second outer radius r₄, but this percentage could be lower or higher, e.g., between 25% and 75%.

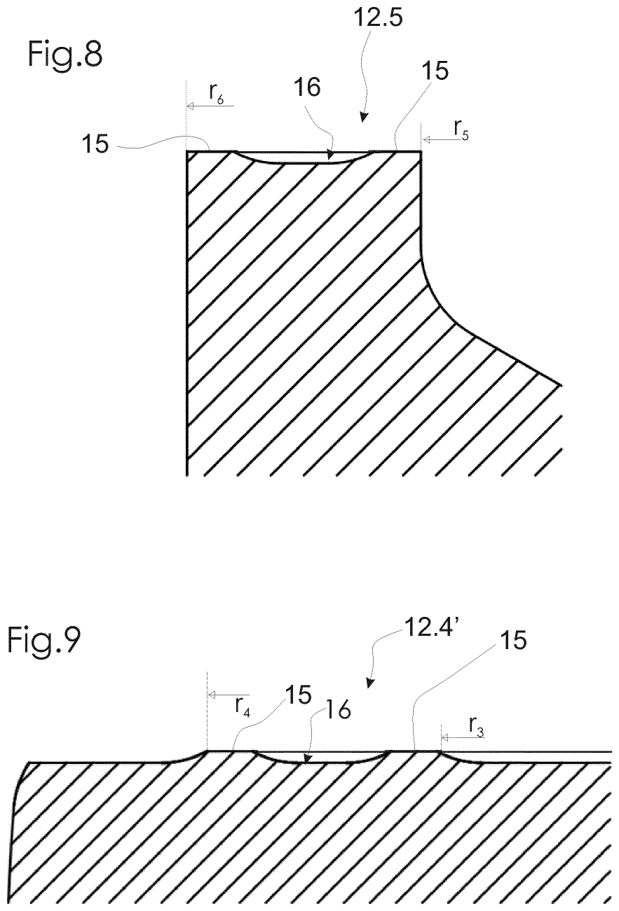

FIG. 8 is a detail of FIG. 4 and illustrates in cross section the lower portion of armature 12 with the third armature contact surface 12.5. This view more clearly shows the two annular contact portions 15 that are concentrically arranged and radially spaced by an interposed annular recess portion 16. Hence the two annular contact portions 15 forms two raised (and flat) surfaces separated by an annular groove constituting the annular recess 16.

FIG. 9 shows, in cross-section, the design of the second armature contact surface, noted 12.4′, of the armature shown in FIG. 4. The configuration is similar to that of the third contact surface 12.5 visible in FIG. 4. The second armature contact surface 12.4′ comprises two annular contact portions 15 that are concentrically arranged and radially spaced by an interposed annular recess portion 16. The first armature contact surface 12.3, which is not shown for this armature 12, may be configured in a similar way.

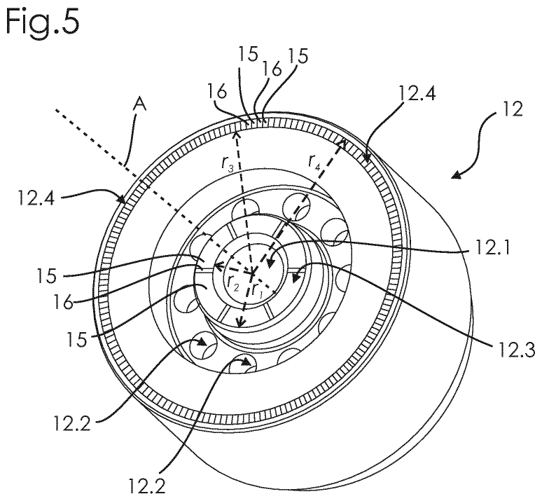

FIG. 5 shows a third embodiment of an armature 12 with still a different type of second armature contact surface 12.4. It comprises a high number (more than 100) of contact portions 15 which are tangentially separated by interposed recess portions 16. Here, the recess portions correspond to 50% of the area between the second inner radius r₃ and the second outer radius r₄. Such surface profile for the divided contact surface can be e.g. manufactured by knurling. Like the first embodiment, this armature is adapted for a diesel injector.

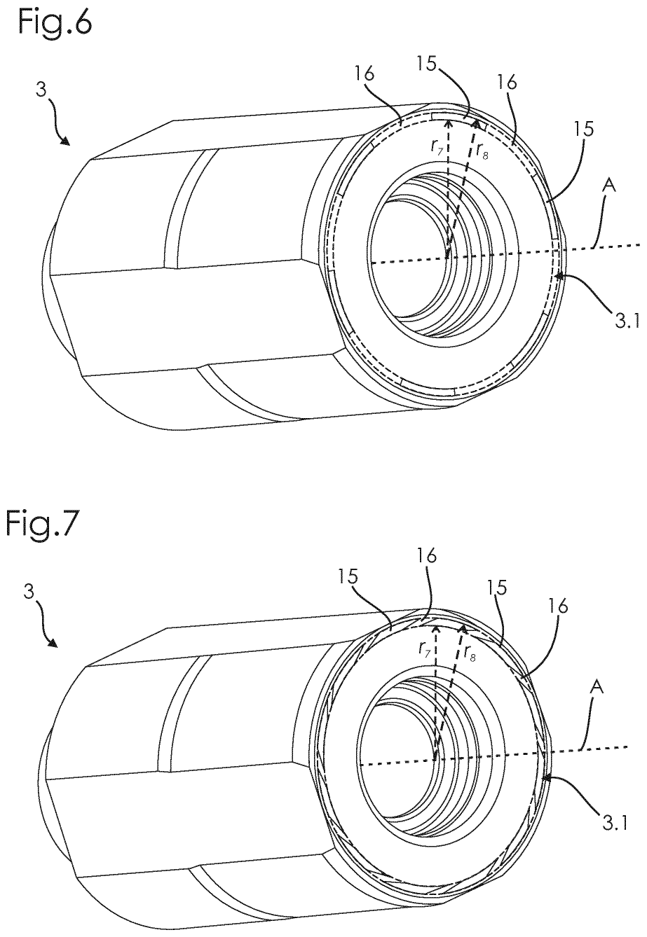

As an alternative to the divided contact surface being disposed on the armature 12, it could be disposed on the pole piece 3, the pintle 10, the stop ring 14 or the housing 2, respectively. FIGS. 6 and 7 show examples in which the pole-piece contact surface 3.1 is a divided contact surface. In these embodiments, the axially opposite second armature contact surface 12.4 is flat. The pole-piece contact surface 3.1 is disposed between a fourth inner radius r₇ and a fourth outer radius r₈. It comprises a plurality of contact portions 15 which are tangentially separated by interposed recess portions 16 which are aligned along the radial direction. Here, the recess portions 16 correspond to about 60% of an area between the fourth inner radius r₇ and the fourth outer radius r₈. This pole-piece can specifically be used in a diesel injector.

The embodiment of FIG. 7 is similar. However, in this case, the recess portions 16 are aligned oblique to the radial direction and the tangential direction, i.e., they correspond to portions of a spiral. Furthermore, the recess portions 16 are smaller, corresponding to about 20% of an area between the fourth inner radius r₇ and the fourth outer radius r₈. This pole-piece can be used in a diesel injector as well as in a gasoline injector.

In the fuel injector 1 shown in FIGS. 1 and 2, the armature 12 and the housing 2 are axially separated by the stop ring 14. In an alternative not shown in the figures, the stop ring 14 could be omitted, with the third armature contact surface 12.5 directly engaging the housing contact surface 2.5, which could then optionally be a divided contact surface.

### LEGEND OF REFERENCE NUMBERS

1 fuel injector
2 housing
2.1 proximal end
2.2 distal end
2.3 housing wall
2.4 stop portion
2.5 housing contact surface
3 pole piece
3.1 pole-piece contact surface
4 nozzle
4.1 nozzle seat
5 magnetic coil
6, 7 spring
8 cavity
10 pintle
10.1 pintle shaft
10.2 pintle perch
10.3 pintle contact surface
11 ball
12 armature
12.1 through-hole
12.2 fuel channel
12.3-12.5 armature contact surface
13 plastic casing
14 stop ring
14.1 stop-ring contact surface
15 contact portion
16 recess portion
A injector axis
r₁, r₃, r₅, r₇ inner radius
r₂, r₄, r₆, r₈ outer radius

1. A fuel injector comprising:
a housing extending axially along an injector axis from a proximal end to a distal end and having a nozzle at the distal end,
a pintle having an axially extending pintle shaft, the pintle-being axially movable between an open position and a closed position in which it closes the nozzle from the inside,
an armature disposed in a cavity of the housing to be axially movable between a proximal position and a distal position and having an axial through-hole in which the pintle shaft is received,
a magnetic coil, and
a pole piece disposed in the housing-proximally of the armature,
wherein at least one axially movable element of the fuel injector comprises a first contact surface for engaging an axially opposite second contact surface of another element, one of said contact surfaces being a divided contact surface that is radially delimited by an inner radius and an outer radius and is projecting towards the other contact-surface, wherein at least two contact portions of the divided contact surface are separated by an interposed recess portion that is recessed with respect to the divided contact surface, and the other contact surface being shaped to engage the divided contact surface while being spaced from each recess portion, wherein the fuel injector is a gasoline injector and at least one divided contact surface comprises two radially spaced contact portions separated by a radially interposed recess portion, or the fuel injector is a diesel injector and at least one divided contact surface comprises two tangentially spaced contact portions separated by a tangentially interposed recess portion.

2. The fuel injector according to claim 1, wherein the armature has a first armature contact surface for engaging an axially opposite pintle contact surface of the pintle and one of the first armature contact surface and the pintle contact surface is a divided contact surface.

3. The fuel injector according to claim 1, wherein the armature has a second armature contact surface for engaging a pole-piece contact surface of the pole piece, and one of the second armature contact surface and the pole-piece contact surface is a divided contact surface.

4. The fuel injector according to claim 1, wherein the armature has a third armature contact surface for engaging an axially opposite contact surface, wherein the third armature contact surface is disposed distally on the armature and one of the third armature contact surface and the axially opposite contact surface is a divided contact surface.

5. The fuel injector according to claim 4, wherein the third armature contact surface is adapted for engaging an axially opposite housing contact surface of the housing, and one of the third armature contact surface and the housing contact surface is a divided contact surface.

6. The fuel injector according to claim 4, comprising a stop ring axially interposed between the armature and the housing, and the third armature contact surface is adapted for engaging an axially opposite stop-ring contact surface of the stop ring, wherein one of the third armature contact surface and the stop-ring contact surface is a divided contact surface.

7. The fuel injector according to claim 1, wherein the radially spaced contact portions are annular.

8. The fuel injector according to claim 4, wherein at least one divided contact surface comprises a plurality of tangentially spaced contact portions and a plurality of tangentially interposed recess portions alternatingly disposed along the tangential direction.

9. The fuel injector according to claim 1, wherein at least one contact portion and/or at least one recess portion is aligned parallel to the radial direction.

10. The fuel injector according to claim 4, wherein at least one divided contact surface comprises a multiplicity of alternating, radially aligned contact portions and recess portions, formed by knurling.

11. The fuel injector according to claim 1, wherein the at least one recess portion corresponds to between 25% and 75% of an area between the inner radius and the outer radius.

12. The fuel injector according to claim 1, wherein the axially opposite contact surface has a minimum curvature radius corresponding to at least 50% of the inner radius.

13. The fuel injector according to claim 1, wherein that at least one recess portion is produced by a forming process and/or a material removing process performed in the area between the inner radius and the outer radius.

14. An engine system with a combustion engine and at least one fuel injector adapted to inject fuel at least indirectly into the engine, the fuel injector comprising:
a housing extending axially along an injector axis from a proximal end to a distal end and having a nozzle at the distal end,
a pintle having an axially extending pintle shaft, the pintle-being axially movable between an open position and a closed position in which it closes the nozzle from the inside,
an armature disposed in a cavity of the housing to be axially movable between a proximal position and a distal position and having an axial through-hole in which the pintle shaft is received,
a magnetic coil, and
a pole piece disposed in the housing proximally of the armature,
wherein at least one axially movable element of the fuel injector comprises a first contact surface for engaging an axially opposite second contact surface of another element, one of said contact surfaces being a divided contact surface that is radially delimited by an inner radius and an outer radius and is projecting towards the other contact surface, wherein at least two contact portions of the divided contact surface are separated by an interposed recess portion that is recessed with respect to the divided contact surface, and the other contact surface being shaped to engage the divided contact surface while being spaced from each recess portion, wherein the engine is a gasoline engine, the fuel injector is a gasoline injector and at least one divided contact surface comprises two radially spaced contact portions separated by a radially interposed recess portion, or the engine is a diesel engine, the fuel injector is a diesel injector and at least one divided contact surface comprises two tangentially spaced contact portions separated by a tangentially interposed recess portion.
